(19) United States
(12) Patent Application Publication
(10) Pub. No.: US 2006/0085816 A1
(43) Pub. Date: Apr. 20, 2006

(54) Method and apparatus to control playback in a download-and-view video on demand system

(76) Inventors: James M. Funk, Menlo Park, CA (US); Steve Shannon, Hillsborough, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/968,196

(22) Filed: Oct. 18, 2004

(51) Int. Cl. H04M 15/00; H04N 7/025; G06Q 40/00; H04N 7/173; H04N 7/10

(52) U.S. Cl. 725/34; 705/34; 705/35; 725/109; 725/113; 725/112

(57) ABSTRACT

Rules concerning whether or not to insert advertisement and/or allow trick mode capabilities during playback of locally stored content downloaded from a content provider's or a VOD service providers server are communicated to the client device and may be specified by a variety of mechanisms including a Web-page based tool for a content provider to edit and for a VOD service provider to review and modify such rules. The client device stores and applies the rules during playback of the content.

### BACKGROUND OF THE INVENTION

1. Field of the Invention

The invention relates generally to the fields of video on demand (VOD) and playback of multimedia content. In particular, the invention relates to enforcing rules to control insertion of advertisements and availability of trick modes (e.g., fast forward, pause and rewind) to a viewer of the multimedia content.

2. Description of Related Technology

Download and View Video-On-Demand

With the recent advances in computing, signal processing and telecommunications technologies, the ability to download and watch audio/video content over a network connection is opening up new opportunities to deploy VOD services.

VOD generally refers to a personalized viewing service offered by a content provider or a network operator over a network to a content viewer. The viewer is able to start a VOD session by electronically browsing through a catalog of available content, selecting a program for viewing and receiving the selected content for viewing via a content device over the network.

Content Distribution and Playback

Generation of revenue by distributing advertisements along with audio/video programs is a business model or component thereof employed by several types of service providers (e.g., over-the-air broadcasters, cable television service providers, etc.). The advertisements are typically inserted into the broadcast stream at a national, regional or local facility (e.g., broadcaster's studio or a cable headend). The advertisements are then played in sequence as users receive these programs from the station (or headend) where the insertion took place.

Digital video recorders (DVRs) introduced in the last few years allow users to store broadcast multimedia content on a hard drive for viewing at a later time. In some DVRs, users are provided with the ability to skip over advertisements (e.g., typically by use of a trick mode feature that allows for “fast forwarding” through the content or skipping ahead a predetermined time interval). This ability to skip advertising is not always provided by consent from the owner or service provider of the content associated with the advertisement. The process of converting content to analog signals and the re-capture of that content in digital form as performed by conventional DVRs makes it difficult to enforce a content provider's and/or a service provider's advertisement insertion or trick mode capability rules.

Another technological advance in the form of unicast content distribution using web servers in the recent years has led to a new model of distributed advertising. A web server serving multimedia content to a user can also send advertisements intended for that particular user, thereby changing the broadcast model of advertisement distribution. Such advertisements (e.g., web page banners) are sent with the content, or fetched from the network during content playback if the device is connected to a network.

A download-and-view VOD service uses both the above mentioned technologies (local storage and content unicasting) to provide VOD service to a user. Therefore, the present inventors have recognized that a method is needed that combines the intricacies and desirable features of both selective advertisement viewing and individualized advertisement insertion features described above.

### SUMMARY OF THE INVENTION

The present invention addresses the foregoing needs by providing, in various embodiments, a method and apparatus for downloading rules associated with playback of advertisement content to a VOD client device and playing advertisements according to those rules. To address the issues associated with usage of trick modes while playing back the content (including advertisements), the present inventors have recognized that a system to download and insert advertisements should preferably also implement a mechanism to turn on or off trick mode capabilities according to the user's program viewing rights. Such a system should also include a facility to allow content providers and/or VOD service providers to be able to specify the advertisement insertion and program viewing trick mode control.

In one aspect of the invention, a method of playing stored content from a computer-readable medium of a set-top appliance to a display device communicatively coupled thereto according to rules provided by an advertising module of the set-top appliance, the rules having been received from a remote server communicatively coupled to the set-top appliance via one or more computer networks and the stored content including one or more advertisements, is disclosed. In some cases, the rules include commands for a processing unit of the set-top appliance, which commands when executed by the processing unit cause the processing unit to disable one or more trick modes during playback of one or more of the advertisements.

In a second aspect of the invention, a method of playing a series of multimedia files from a computer-readable medium of an appliance in a sequence determined by rules for playing advertisements and in response to a single selection operation of a viewer indicating a desire to view one of the series of multimedia files, the rules having been received from a remote server communicatively coupled to the appliance via one or more computer networks, is disclosed.

In a third of the invention, an appliance having a computer-readable medium on which one or more multimedia files are stored disclosed. This appliance includes a computer processor coupled to the computer-readable medium and configured, under programmable control, to cause to be played out some or all of the multimedia files in a sequence determined by rules for playing advertisements and in response to a single selection operation of a viewer indicating a desire to view one of the series of multimedia files. In some cases the rules include commands for the computer processor, which when executed by the computer processor cause the computer processor to disable one or more trick modes during playback of the one or more of the multimedia files.

In a fourth aspect of the invention, a user interface having one or more Web forms configured to permit a content provider to create, and a service provider to review and modify rules of advertisement insertion and trick mode capabilities is disclosed.

### BRIEF DESCRIPTION OF THE DRAWINGS

The above and other features and advantages of the present invention are hereinafter described in the following detailed description of illustrative embodiments to be read in conjunction with the accompanying drawings, wherein like reference numerals are used to identify the same or similar system parts and/or method steps, and in which:

FIG. 1 is a functional block diagram illustrating an exemplary IP network configuration useful with the present invention.

FIG. 2 illustrates an exemplary decision flow implemented according to the present invention when deciding to insert one or more advertisements during content playback.

FIG. 3A illustrates an example of a user interface in the form of a web page that is used, according to an embodiment of the present invention, for controlling trick mode capabilities associated with the playback of a program by a user.

FIG. 3B illustrates an example of a user interface in the form of a web page that is used, according to an embodiment of the present invention, for controlling advertisement insertion rules associated with the playback of a program by a user.

FIG. 4 shows an illustrative embodiment of the steps taken at a client device to enforce rules of advertisement insertion and trick modes, during the playback of content and in accordance with an embodiment of the present invention.

### DETAILED DESCRIPTION

Reference is now made to the drawings wherein like numerals refer to like parts throughout. Described herein is a method and apparatus to control the playback of content in a download-and-view video on demand system.

As used herein, the term “VOD” is meant to include on-demand delivery of audio, video, graphical icons, software, computer games, etc.

As used herein, the term “VOD server” is meant to include network-side server resources of a VOD system in the form of a computing platform, including content servers, billing system servers, web interface servers, the network operator's management servers, and so on.

As used herein, the term “VOD service provider” is meant to refer to an entity, other than a home or end-user, involved in manufacturing, design, deployment or maintenance of a system embodying the present invention, including but not limited to cable system operators, satellite providers, DSL internet providers, content providers, client device manufacturers, etc. as appropriate.

As used herein, the term “content” refers to audio, video, graphics files (in uncompressed or compressed format), icons, software, text files and scripts, data, binary files and other computer-usable data used to operate a client device and produce desired audio-visual effects on a client device for the viewer.

In view of the above, it should be appreciated that some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices. Where illustrated, the user interfaces presented herein should be regarding as examples thereof and not read so as to limit the scope of the present invention. Layouts, images and other elements of such user interfaces are not critical to the present invention. The functionality provided by such interfaces is reflected in the claims following this description and it is that functionality which forms a component of the present invention.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the present invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, etc.), as taking an action or causing a result. Such expressions are merely a shorthand way of saying that execution of the software by a computer causes the processor of the computer to perform an action or produce a result.

Overview

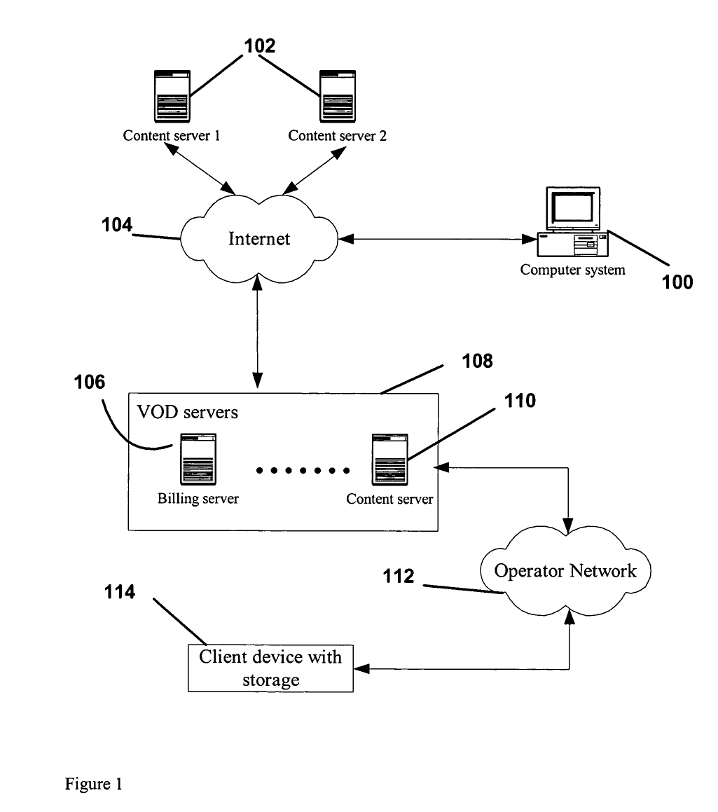

FIG. 1 shows a block diagram of an exemplary computer network in which the present invention can be implemented. The figure shows a computer system 100, content servers 102 and a group of VOD servers (shown as box 108), all communicatively coupled to each other via a network 104. The group of VOD servers consists of server(s) that perform functions such as billing and account management (106) and hosting of VOD content and a program guide (110). These VOD servers are communicatively coupled with a VOD client device 114, via an Internet service provider's operator network 112. This network diagram represents typical Internet connectivity available to residential users, but is not intended to limit the present invention. In practical situations, some variations to this network configuration are possible. For example, in the case when a user browses the Internet using a home computer, the computer system 100 will also often be connected to the network 104 through the operator network.

Controlling Playback Features of Content

The flow of content in a download-and-view VOD network as described in the above example, is generally from a content provider's server(s) to a user's client device, possibly via a VOD service provider's server(s). Information and control settings regarding trick mode privileges given to a user and whether the content is offered free of advertisements will generally follow the same flow.

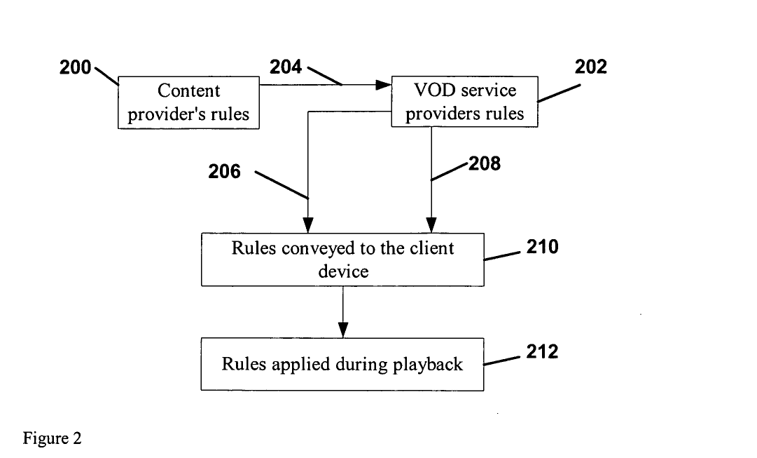

Referring to FIG. 2, a content provider's rules (200) are conveyed via a communication path (204) to the VOD service provider. Such rules may be conveyed when provisioning a program (program-specific) or for a user or group of users (user-specific) or as a part of other business transactions (e.g., an agreement to offer advertisement-free content, or tiered advertisements, and so on). In some cases, upon reception of rules 200 from the content provider, the VOD service provider may modify these rules using the service provider's rules 202, which in some cases could supersede the content provider's settings. For example, the content provider rules may indicate that advertisement insertion prior to a program is allowed, but the VOD service provider may want to insert advertisements and may change the setting so that advertisements can be inserted during playback by the client device.

Regardless of their origin, the rules are conveyed to the client device (208). Such communication may occur as instructions embedded in a program and received during download of a program or may occur as a part of a non-multimedia “house keeping” data transfer between a client device and a VOD server. Certain advertisement and trick mode rules may also be created by the VOD service provider independent of any association with a particular set of rules from a content provider. Such rules will also be conveyed to a client device (signal 206), as needed.

A client device stores the rules thus conveyed (210) for use during program playback. After the rules are used during playback of a program (212), depending on the nature of the rules, some rules may be discarded while others may be retained for future use in connection with other programs.

Descriptions of Exemplary Embodiments

Various embodiments of the above-described method may be implemented. Exemplary embodiments are described below to further illustrate the present invention. The Web pages described below may be implemented as part of a VOD service provider's overall facility for interaction with content providers. In such a case, the pages would generally be hosted at servers or other computer resources generally accessible to content providers (e.g., via a Web browser or similar application via one or more computer networks). The precise nature of the computer resources, their interconnection and/or their other functionalities is not critical to the present invention.

Trick Modes Console

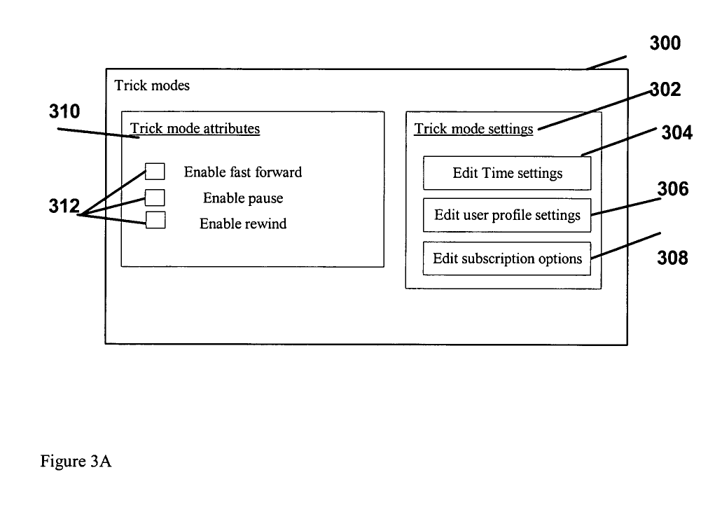

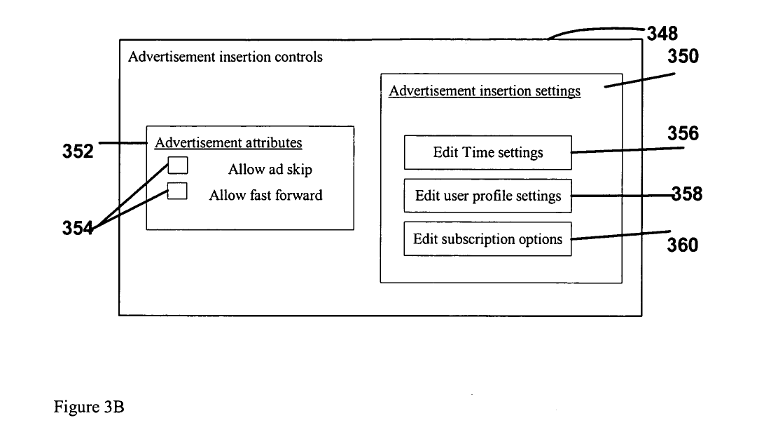

Referring to FIG. 3A, an exemplary embodiment of a Web page 300 used to set trick mode options is shown. In some implementations, such a control facility may be offered as a part of a computer-based tool (accessible, for example, via the World Wide Web or other user interface) made available to a content provider by a service provider. An example of such a tool is described in co-pending U.S. patent application Ser. No. ______ (Attorney Docket No. 7177P003) entitled “Method and apparatus for content provisioning in a video on demand system” filed XXXX, 2004, assigned to the assignee of the present invention and incorporated herein by reference. Various other methods can be implemented to convey a content provider's trick mode settings related to a program, a user or a group of users or to all users subscribing to the content provider's content.

Web page 300 is thus only one example of a trick mode console by which a content provider may specify trick mode settings to be implemented during playback of the provider's associated multimedia content at a client device. Such a control facility is nevertheless important and valuable because it offers some assurance to the content provider that the content will be played out in accordance with the provider's wishes. For example, advertisers may insist on such a control or assurance in exchange for providing a VOD service provider with fees for distributing advertisements.

The web page 300 is grouped into functional areas—one portion to enter trick mode attributes (310) and the other to enter trick mode settings (302). As shown in the figure, the trick mode settings portion is further split into three functional areas: one enabling editing of time settings (304), a second one enabling editing of user profile settings (306) and a third area enabling editing of subscription option settings (308). The time settings functional area could further include control options that allow the content provider to set trick mode playback capabilities that are sensitive to time (e.g., no trick modes allowed during prime time or enable trick modes during a special promotion time, etc.). The user profile settings functional area groups trick mode options that depend on the profile of a user and whether trick modes are allowed for that status. The subscription settings option functional area contains options that depend on the availability of trick modes subscription status of a user. This functional area could for example be used to select a setting that allows trick modes during playback to a tier of subscribers who have paid extra fees for such capabilities. In some implementations, clicking on each of the three buttons (304, 306 and 308) will open further Web pages (or other user interface elements) related to each functional area.

Advertisement Console

A console that controls the advertisement playback options also can be offered as a part of a computer-based tool, for example as described in the above-mentioned patent application, or as a stand-alone tool.

An exemplary embodiment of a content provider's advertisement console is shown in FIG. 3B in the form of a simple Web page. The page 348 is divided in two functional areas. The first area consists of advertisement attributes (352) that contain controls 354 (e.g., check-boxes) that enable or disable attributes such as whether the advertisement can be skipped or fast-forwarded during the playback. The second functional area (350) consists of advertisement insertion settings that further include dialog areas that can for example be accessed by clicking control buttons to edit time settings (356), user profile settings (358) and subscription option settings (360). The time settings dialog page could include control options to allow setting of advertisement playback attributes, based on time of the day, day of the week, special promotion period, and so on. The user profile settings dialog page could further include advertisement attribute control based on user profiles. The subscription options settings dialog page could further allow settings based on subscription tier of a user (e.g., premier users could skip advertisements).

It should be noted that the attributes control provided in an advertisement control is intended to control playback of advertisements inserted before, during or after a program.

Actions by the Service Provider

The trick mode and advertisement rules set by a content provider using a tool such as the ones described above are further reviewed and possibly modified by a VOD service provider in accordance with the VOD service provider's business rules. An exemplary method for a review process used to provision content is described in the above-referenced patent application.

Rules Metadata

The rules thus created by one or more of a content provider and a service provider's input can be conveyed to a client device using several methods. In one embodiment, the rules are included in program guide metadata such that when a client device downloads the guide, the information regarding trick mode and advertisement insertion settings is available for each program. Such rules could instruct the client device (e.g., a processor or other module therein) whether or not to insert advertisements before, during or after playback of a program, how many advertisements to insert; the duration of the insertion, which advertisements to insert (a specific advertisement, a genre of advertisement, etc.) and whether trick modes should be allowed during advertisement playback (e.g., in general or on an advertisement-by-advertisement basis). Of course, such playback rules are not limited to advertisements but may apply to any content elements, such as information from a service provider to a user regarding upcoming features or events, the user's account, planned service outages or enhancements, and so on.

Storage on a Client Device

The rules data associated with trick modes and advertisement insertion; including, preferably, the advertisements themselves are stored locally on a client device. To enable playback of content without having to keep a client device connected to the network, it is desirable to download and locally store the advertisement content used for insertion. However, in some implementations, where network connectivity is maintained during content playback, such data could also be stored on another storage device communicatively connected to the client device over a network. Examples of such an implementation include an advertisement server that caches and serves advertisements to all client devices on a user's home network.

Content Viewing Manager

The content viewing manager is responsible for fulfilling a user's request to view certain multimedia titles. The content viewing manager performs this fulfillment by identifying where the content is located on local storage medium and enabling a flow of the content to the display, where necessary using appropriate decoders, encoders, and so on.

The content viewing manager also determines (based on the previously downloaded rules) whether to insert advertisements before, during or after the playback and whether or not to turn off trick mode options during the playback. The rules may be available, for example, with guide metadata associated with a program (e.g., metadata indications that the program trick modes are allowed during the program), with a user's profile (e.g., “trick mode always on”) or another time-based global setting (e.g., “skip advertisements during prime time”).

Implementation of Trick Modes

A skilled practitioner will appreciate that the details of how trick modes are applied to a program depend on the format used to represent and store the program. For example, when audio/video streams are stored in the MPEG-2 format, trick modes may be implemented by skipping the “P” and “B” frames and displaying the “I” frames only. The present invention makes no assumptions about and is not limited by how trick modes are implemented during playback, whether playback is performed using software or hardware audio/video decoders, the choice of speed of fast-forward or rewind trick modes, and so on.

Implementation of Playback Rules

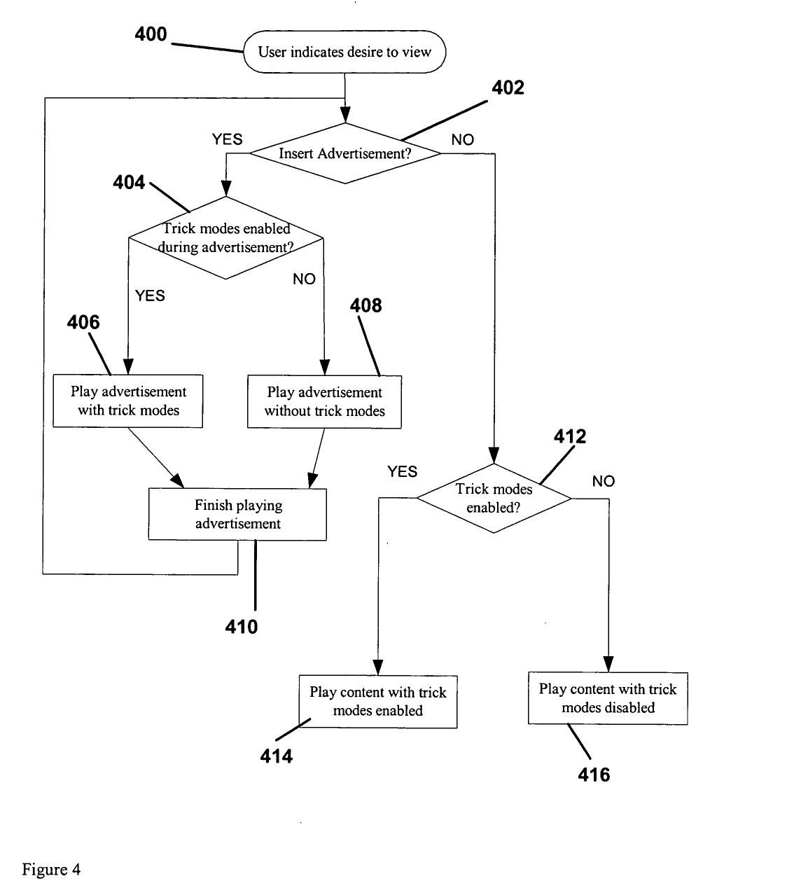

Referring to FIG. 4, when a user selects a program to watch (400), the request is processed by the content viewing manager to decide whether an advertisement is to be inserted (402). This decision will be based on the various rules provided to the client device by the content provider(s) and/or by the VOD service provider. If an advertisement is to be inserted, the content viewing manager then checks to see if a trick mode feature is to be allowed during playback of the advertisement (step 404). This decision will be based on the rules provided to the client device and/or the profile of the user watching the program, among other things. If trick modes are allowed (e.g., enabling a user to skip or fast forward through an advertisement), an advertisement is played back (406) while allowing trick mode controls by the user. The decision of which advertisement to play back is made based on several criteria, including without limitation, time criteria, program genre, user profile, special promotions, and so on. If trick modes are not allowed, the advertisement is played back without the trick mode controls enabled (408). When the playback is complete (step 410), the process returns to 402, where the content viewing manager checks to see if another advertisement needs to be inserted.

If, in step 402, the content viewing manager decides that no advertisement is to be played back, the viewing manager moves one step closer to playing back the content desired by the user. Before the content is played out, however, a check is made to see if trick modes are allowed (412). The content is accordingly played back with trick modes allowed (414) or without trick modes allowed (416). In some embodiments, the step 412 may provide a time window feedback to the content viewing manager (e.g., trick modes disabled during first segment or a time window of the program and allowed thereafter).

In the foregoing specification, the invention has been described with reference to specific exemplary embodiments thereof. It will, however, be evident to those of ordinary skill in the art that various modifications and changes may be made thereto without departing from the broader spirit and scope of the invention as set forth in the appended claims. The specification and drawings are, accordingly, to be regarded in an illustrative rather than a restrictive sense and that it understood that the following claims including all equivalents are intended to define the scope of the invention.

What is claimed is:

1. A method, comprising playing out stored content from a computer-readable medium of a set-top appliance to a display device communicatively coupled thereto according to rules provided by an advertising module of the set-top appliance, the rules having been received from a remote server communicatively coupled to the set-top appliance via one or more computer networks and the stored content including one or more advertisements.

2. The method of claim 1, wherein the rules include commands for a processing unit of the set-top appliance which commands when executed by the processing unit cause the processing unit to disable one or more trick modes during playback of one or more of the advertisements.

3. The method of claim 2, wherein the commands are executed or not according to decisions of advertisers providing the one or more advertisements.

4. The method of claim 1, wherein different ones of the rules are applicable to the playing out of the stored content according to whether or not a viewer has paid a fee for viewing the stored content.

5. The method of claim 4, wherein the rules include commands for a processing unit of the set-top appliance which rules when executed by the processing unit cause the processing unit to disable one or more trick modes during playback of one or more of the advertisements.

6. The method of claim 1, wherein the rules are based on one or more of the following: viewer profile, viewer subscription agreement, advertising campaigns, time of day, day of week, and number of times the stored content has been viewed.

7. The method of claim 1, further comprising reporting playback of the one or more advertisements to advertisers associated therewith.

8. A method, comprising playing a series of multimedia files from a computer-readable medium of an appliance in a sequence determined by rules for playing advertisements and in response to a single selection operation of a viewer indicating a desire to view one of the series of multimedia files, the rules having been received from a remote server communicatively coupled to the appliance via one or more computer networks.

9. The method of claim 8, wherein the rules include commands for a processing unit of the appliance which commands when executed by the processing unit cause the processing unit to disable one or more trick modes during playback of one or more of the series of multimedia files.

10. The method of claim 8, wherein the multimedia files include content downloaded from one or more Internet hosts.

11. The method of claim 10, wherein the rules are configured to avoid playing of advertisements if a viewer has paid for downloading a selected one of the multimedia files.

12. The method of claim 10, wherein different ones of the rules are applicable to the playing out of the multimedia files according to whether or not a viewer has paid a fee for downloading some or all of the multimedia files.

13. The method of claim 10, wherein the rules include commands for a processing unit of the appliance which commands when executed by the processing unit cause the processing unit to disable one or more trick modes during playback of one or more of the series of multimedia files.

14. The method of claim 10, wherein the rules are based on one or more of the following: viewer profile, viewer subscription agreement, advertising campaigns, time of day, day of week, and number of times one or more of the multimedia files has been viewed.

15. An appliance, comprising a computer-readable medium having stored thereon one or more multimedia files and a computer processor coupled to the computer-readable medium and configured, under programmable control, to cause to be played out some or all of the multimedia files in a sequence determined by rules for playing advertisements and in response to a single selection operation of a viewer indicating a desire to view one of the series of multimedia files.

16. The appliance of claim 15, wherein the rules include commands for the computer processor which when executed by the computer processor cause the computer processor to disable one or more trick modes during playback of the one or more multimedia files.

17. The appliance of claim 15, wherein the rules are configured to avoid playing of advertisements if a viewer has paid for downloading one or more of the multimedia files.

18. The appliance of claim 15, the rules are based on one or more of the following: viewer profile, viewer subscription agreement, advertising campaigns, time of day, day of week, and number of times one or more of the multimedia files has been viewed.

19. The appliance of claim 15, wherein the rules are stored on a second computer-readable medium accessible by the computer processor.

20. The appliance of claim 19, wherein the rules are updated via communications with a remote server communicatively coupled to the appliance via one or more computer networks.

21. A user interface, comprising one or more Web forms configured to permit setting of trick mode controls associated with multimedia content to a program guide distributable to remote set-top appliances configured to permit downloading of the multimedia content from Internet hosts.

22. The user interface of claim 21, further configured to permit setting of advertising insertion settings associated with the multimedia content.

23. The user interface of claim 22, further including a provider portion and a reviewer portion, the provider portion configured to permit a provider of the multimedia content to enter a plurality of trick mode and advertisement insertion settings, and the reviewer portion configured to permit a human reader to review, accept, modify or reject the settings provided by the provider.
